(19) United States
(12) Patent Application Publication
(10) Pub. No.: US 2020/0412008 A1
(43) Pub. Date: Dec. 31, 2020

(54) ANTENNA DEVICE AND LOW-PROFILE ANTENNA

(71) Applicant: AAC Technologies Pte. Ltd., Singapore city (SG)

(72) Inventors: Jianchuan Liu, Shenzhen (CN); Yuehua Yue, Shenzhen (CN); Qingchen Chu, Shenzhen (CN)

(21) Appl. No.: 16/997,900

(22) Filed: Aug. 19, 2020

Related U.S. Application Data
(63) Continuation of application No. PCT/CN2019/094087, filed on Jun. 30, 2019.

(51) Int. Cl. H01Q 15/24; H01Q 1/50

(52) U.S. Cl. CPC H01Q 15/242; H01Q 1/50

(57) ABSTRACT

The antenna device includes first and second metal plates; parasitic posts each having one end electrically connected to the first metal plate and the other end in no electrical connection; four feeding posts each having one end electrically connected to the first metal plate; and a feeding plate provided with two differential feeding ports each electrically connected to two feeding posts. A straight line connecting connection points at which the two feeding posts corresponding to one differential feeding port are connected to the first metal plate, is orthogonal to a straight line connecting connection points at which the two feeding posts corresponding to the other one differential feeding port are connected to the first metal plate, to allow the antenna device to generate orthogonal polarization. The antenna device has a small diameter and a low height to allow the antenna to be conformal to a carrier in limited space.

### TECHNICAL FIELD

The present invention relates to the field of communication technology, and particularly, to an antenna device and a low-profile antenna.

### BACKGROUND

MassiveMIMO is one of key technologies of 5^{th} generation wireless systems (5G). The theoretical studies, laboratory tests, and field tests have all indicated that the MassiveMIMO technology can greatly improve the performances of 5G systems Compared to the conventional base station antennas or the conventional integrated active antennas, the MassiveMIMO antennas have a morphological difference in that the number of arrays is very large and units have independent transceiver capabilities. The large-scale antenna arrays have multi-beam capabilities and increase a network capacity, while beamforming improves single-user SINK and coverage of various scenarios; and multi-channel receiving up and down can maximize uplink reception gain.

Compared to the conventional base station antenna, the MassiveMIMO antenna and a remote radio unit (RRU) are integrated, which requires conformation of the antenna and a carrier. Thus, it is challenging to achieve commonality in limited space.

Therefore, it is necessary to provide an antenna having a small diameter and a low height, in order to be conformal with to the carrier in limited space.

### SUMMARY

Objects of the present invention are to provide an antenna device and a low-profile antenna, for solving the technical problem of commonality difficulty in limited space.

Technical solutions of the present invention is described as below.

In a first aspect, the present invention provides an antenna device, including: a first metal plate; a second metal plate spaced apart from and parallel to the first metal plate in a normal direction of the first metal plate; a plurality of parasitic posts, wherein each of the plurality of parasitic posts has one end electrically connected to the first metal plate and facing away from the second metal plate, and the other end in no electrical connection; four feeding posts, wherein each of the four feeding posts has one end electrically connected to the first metal plate and facing away from the second metal plate; and a feeding plate provided with two differential feeding ports, wherein each of the two differential feeding ports is electrically connected to two of the four feeding posts through a differential feeding wire. A straight line connecting connection points, at which the two feeding posts corresponding to one of the two differential feeding ports are connected to the first metal plate, is orthogonal to a straight line connecting connection points, at which the two feeding posts corresponding to the other one of the two differential feeding ports are connected to the first metal plate, to allow the antenna device to generate orthogonal polarization.

As an improvement, the plurality of parasitic posts comprises four parasitic posts, and every two of the four parasitic posts are symmetrically arranged at two ends of the two feeding posts corresponding to a same one of the two differential feeding ports, connection points, at which the four feeding posts are connected to the first metal plate, are connected to form a first square, connection points, at which the four parasitic posts are connected to the first metal plate, are connected to form a second square, and two parallel side edges of the first square are parallel to two parallel side edges of the second square.

As an improvement, the antenna device further includes an insulation bracket fixed to the feeding plate, wherein the insulation bracket comprises a supporting base spaced apart from and parallel to the feeding plate, a first supporting post extending from the supporting base to the feeding plate and connected to the feeding plate, and a second supporting post extending from the supporting base to the feeding plate and spaced apart from the feeding plate, the first metal plate is provided on a surface of the supporting base facing towards the feeding plate, the four feeding posts are provided on a surface of the first supporting post, and the plurality of parasitic posts is disposed on a surface of the second supporting post.

As an improvement, the second metal plate is riveted to the supporting base through plastic rivets.

As an improvement, at least one of the first metal plate and the second metal plate is provided with a groove.

As an improvement, the groove is in a shape of circle or square.

As an improvement, a distance between a surface of the feeding plate facing away from the four feeding posts and a surface of the second metal plate facing away from the four feeding posts is a height of the antenna device, and the height of the antenna device is 7.5 mm, a working frequency of the antenna device ranges from 3.4 GHz to 3.6 GHz.

In a second aspect, the present invention further provides a low-profile antenna, including at least one antenna device, each of the at least one antenna device being the antenna device as described in the first aspect.

As an improvement, the at least one antenna device comprises a plurality of antenna devices, the plurality of antenna devices is arranged in arrays to form a plurality of array elements, and the plurality of array elements is arranged in arrays to form the low-profile antenna.

The beneficial effects of the present invention lie in: by providing double layers of the metal plates as radiators, the bandwidth is effectively broadened, thereby reducing a profile height of the antenna device; in addition, by providing the parasitic posts between the first metal plate and the feeding plate, the bandwidth is further broadened, and a frequency band is reduced, thereby reducing the profile height and a lateral dimension of the antenna device. Therefore, the antenna device of the present invention has a small diameter and a low height, allowing the low-profile antenna to conform to a carrier in limited space.

### BRIEF DESCRIPTION OF DRAWINGS

FIG. 1 is a structural schematic diagram of an antenna device of the present invention;

FIG. 2 is an exploded view of the antenna device shown in FIG. 1;

FIG. 3 is a side view of the antenna device shown in FIG. 1;

FIG. 4 is a bottom view of the antenna device shown in FIG. 1; and

FIG. 5 is a top view of the antenna device shown in FIG. 1.

### DESCRIPTION OF EMBODIMENTS

The present invention will be further described below with reference to the accompany drawings and embodiments.

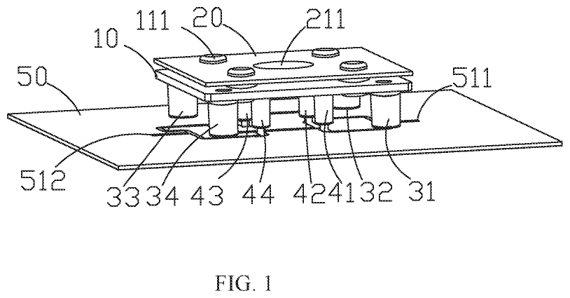

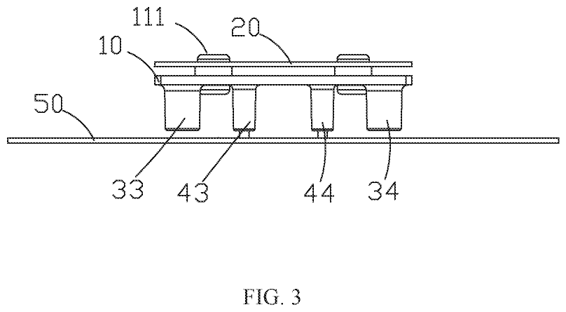

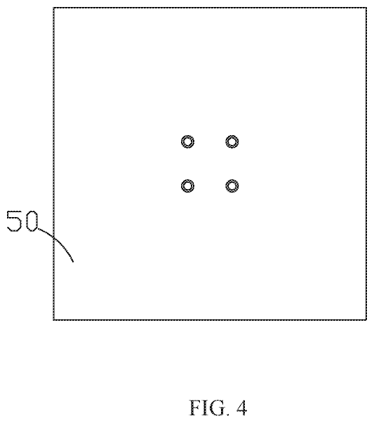

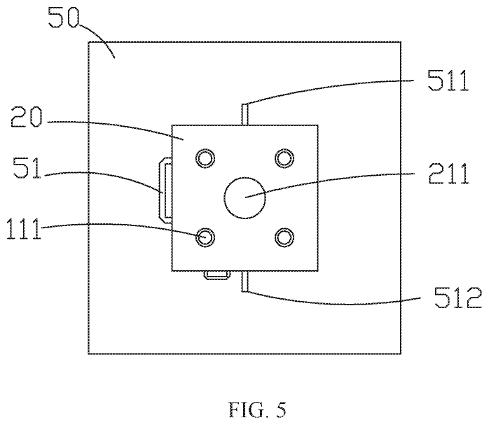

Referring to FIGS. 1 to 5, a low-profile antenna provided by an embodiment of the present invention includes at least one antenna device. The antenna device includes a first metal plate 10, a second metal plate 20, a plurality of parasitic posts (31, 32, 33, 34), four feeding posts (41, 42, 43, 44), and a feeding plate 50, for transmitting and receiving signals. FIGS. 1 to 3 illustrate four parasitic posts, but it can be understood that the number of the parasitic posts may be more than four. The first metal plate 10 is used for radiation, and the second metal plate 20 is used for radiation and guidance. The parasitic posts (31, 32, 33, 34) are configured to generate resonance in order to widen a working bandwidth of the antenna device.

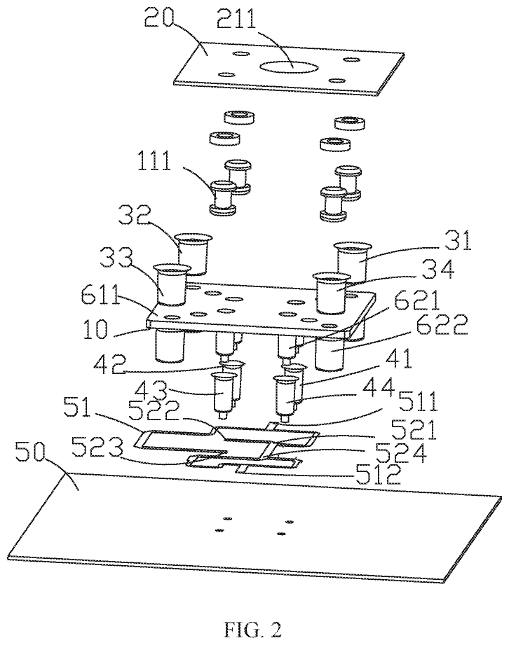

Referring to FIGS. 1 and 2, the first metal plate 10, the second metal plate 20, the parasitic posts (31, 32, 33, 34), the feeding posts (41, 42, 43, 44), and the feeding plate 50 are manufactured by any process of printed circuit board (PCB) made by electronic printing, laser direct structuring (LDS), plastic electroplating, die casting, stamping, and 3D (a technology using adhesive materials such as powdered metal or plastic to construct objects by layer-by-layer printing). It can be understood that the first metal plate 10, the second metal plate 20, the parasitic posts (31, 32, 33, 34), the feeding posts (41, 42, 43, 44), and the feeding plate 50 can also be manufactured by other processes. Interior of the first metal plate 10, the second metal plate 20, the parasitic posts (31, 32, 33, 34), the feeding posts (41, 42, 43, 44), and the feeding plate 50 can be a non-conductive bracket, and a surface of the bracket is covered with a conductive layer, thereby reducing a weight of the antenna device. The first metal plate 10, the second metal plate 20, and the feeding plate 50 may be planar plates in a shape of, for example, circle, parallelogram, square; or they may be non-planar plates such as curved plates, arc-shaped plates, and the like, which is not specifically limited herein. The four parasitic posts (31, 32, 33, 34) have the same size and shape, and they may be, for example, cylindrical, conical, cuboid, etc., which is not specifically limited herein. The four feeding posts (41, 42, 43, 44) have the same size and shape, and they may be, for example, cylindrical, conical, cuboid, etc., which is not specifically limited here. Diameters and heights of the parasitic posts (31, 32, 33, 34) and the feeding posts (41, 42, 43, 44) are selected according to materials and overall structural requirements of the antenna device, which are not specifically limited herein.

In the present invention, the first metal plate 10 and the second metal plate 20 are arranged parallel to each other and spaced apart from each other in a normal direction of the first metal plate 10; each of the parasitic posts (31, 32, 33, 34) has one end electrically connected to the first metal plate 10 and facing away from the second metal plate 20, and the other end in no electrical connection; one end of each of the four feeding posts (41, 42, 43, 44) is electrically connected to the first metal plate 10 and faces away from the second metal plate 20; the feeding plate 50 is provided with two differential feeding ports (511, 512), and each of the differential feeding ports (511, 512) is electrically connected to two feeding posts (41 and 43, 42 and 44) through a differential feeding wire 51. By providing double layers of the metal plates, i.e., the first metal plate 10 and the second metal plate 20, as radiators, the bandwidth is effectively broadened, thereby reducing a profile height of the antenna device. In addition, by providing the parasitic posts (31, 32, 33, 34) between the first metal plate 10 and the feeding plate 50, the bandwidth is further broadened and a frequency band is narrowed, thereby reducing the profile height and a sectional dimension of the antenna device. Therefore, the antenna device of the present invention has a small diameter and a low height to allow the low-profile antenna to be conformal to a carrier in limited space.

Referring to FIG. 2, the differential feeding wire 51 is located on the feeding plate 50, and the differential feeding wire 51 is configured to differentially feed the four feeding posts (41, 42, 43, 44). The differential feeding wire 51 is provided with four feeding interfaces (521, 522, 523, 524), and the four feeding ports (521 and 523, 522 and 524) are fed with power through two differential feeding ports (511, 512). For example, the feeding interfaces (521 and 523) are fed with power through the differential feeding port 511, the feeding interfaces (522 and 524) is fed with power through the differential feeding port 512. The feeding posts (41, 42, 43, 44) correspond to the feeding interfaces (521, 522, 523, 524) in one-to-one correspondence, and the feeding posts (41, 42, 43, 44) are welded to and electrically connected to the feeding interfaces (521, 522, 523, 524). A wiring form of the differential feeding wire 51 can be designed according to the shape of the feeding plate 50 and power feeding requirements, which is not specifically limited herein.

In the present invention, a straight line connecting connection points where the two feeding posts (41 and 43) corresponding to one differential feeding port (511) are connected to the first metal plate 10, is orthogonal to a straight line connecting connection points where the two feeding posts (42 and 44) corresponding to the other one differential feeding port (512) are connected to the first metal plate 10, thereby allowing the antenna device to generate orthogonal polarization. Each antenna device are provided with the two differential feeding ports (511, 512), each of which is fed with power through the differential feeding wire 51, allowing the first metal plate 10 and the second metal plate 20 to generate linear polarization in one direction. The two differential feeding ports (511, 512) correspond to the same working frequency band, and they can be operated simultaneously and independently. The orthogonal polarization results in orthogonal polarization directions of these two ports, which generates isolation between the polarization directions of the two ports, thereby avoiding signal interference and improving the quality of the signals received and transmitted by the antenna. It can be understood that the materials of the first metal plate 10, the second metal plate 20, the four parasitic posts (31, 32, 33, 34) and the four feeding post (41, 42, 43, 44) as well as the overall structural requirements of the antenna device determine the feeding posts (41 and 43, 42 and 44) located on the same straight line, which are not specifically limited here.

Central axes of the parasitic posts (31, 32, 33, 34) and the feeding posts (41, 42, 43, 44), which are located at the same end of the same diagonal line of the parallelogram, are parallel, which improves the quality of the signals received and transmitted by the antenna.

In a preferred embodiment of the present invention, the four parasitic posts (31, 32, 33, 34) and the four feeding posts (41, 42, 43, 44) are perpendicular to a plane where the first metal plate 10 is located, which is conducive to the production and processing and further improves the quality of the signals received and transmitted by the antenna.

Referring to FIG. 2, in a preferred embodiment of the present invention, the antenna device further includes an insulation bracket (611, 621, 622) fixed to the feeding plate 50. The insulation bracket includes a supporting base 611 spaced apart from and parallel to the feeding plate 50, a first supporting post 621 extending from the supporting base 611 to the feeding plate 50 and connected to the feeding plate 50, and a second supporting post 622 extending from the supporting base 611 to the feeding plate 50 and spaced apart from the feeding plate 50. The first metal plate 10 is provided on a surface of the supporting base 611 facing towards the feeding plate 50, the feeding posts (41, 42, 43, 44) are provided on a surface of the first supporting post 621, and the parasitic posts (31, 32, 33, 34) are disposed on a surface of the second supporting post 622. In this way, a better supporting force is provided between the first metal plate 10 and the feeding plate 50, which avoids a deformation of the antenna device caused by an external force, thereby improving product quality. The feeding posts (41, 42, 43, 44) and the first supporting post 621 are manufactured separately and then assembled, and the parasitic posts (31, 32, 33, 34) and the second supporting post 622 are manufactured separately and then assembled, thereby facilitating disassembly and maintenance and reducing maintenance cost.

In a preferred embodiment of the present invention, the feeding posts (41, 42, 43, 44) and the first supporting post 621 are formed into one piece, and the parasitic posts (31, 32, 33, 34) and the second supporting post 622 are formed into one piece, thereby reducing assembly cost.

In a preferred embodiment of the present invention, the second metal plate 20 is riveted to the supporting base 611 through plastic rivets, and the plastic rivets do not cause interference with radiation signals of the second metal plate 20, thereby further improving the quality of the signals received and transmitted by the antenna.

In the present invention, the height of the antenna device is related to the frequency band, the higher the frequency band, the lower the height of the antenna device. In the present invention, the height of the antenna device is 7.5 mm, which may vary up and down by 5%, the working frequency of the antenna device ranges from 3.4 GHz to 3.6 GHz. In such a frequency band, a conventional half-wave antenna has a height of 20 mm, which may vary up and down by 5%, and a height of 10 mm, which may vary up and down by 5%. Thus, it is obvious that, in the same working frequency band, the height of the antenna device of the present invention is lower than that of the traditional antenna, such that the low-profile antenna using the antenna device of the present invention can be effectively conformal to the carrier in the limited space. It can be understood that the antenna device of the present invention can also transmit and receive signals in frequency bands of 1.8 GHz, 2.5 GHz, 3.5 GHz, and 4.8 GHz.

In a preferred embodiment of the present invention, the number of the parasitic posts is four, and every two of the four parasitic posts are symmetrically arranged at two ends of the two feeding posts (41 and 43, 42 and 44) corresponding to the same differential feeding port (511, 512), the connection points, at which the four feeding posts (41, 42, 43, 44) are connected to the first metal plate 10, are connected to form a first square, and the connection points, at which the four parasitic posts (31, 32, 33, 34) are connected to the first metal plate 10, are connected to form a second square. Two parallel side edges of the first square are parallel to two parallel side edges of the second square. Two diagonal lines of each square intersect perpendicularly, which achieves the orthogonal polarization of the polarization directions of the two ports, and the polarization directions of the two ports are optimally isolated from each other, thereby further avoiding mutual interference and further improving the quality of the signals received and transmitted by the antenna.

In a preferred embodiment of the present invention, the first metal plate 10 and/or the second metal plate 20 are provided with a groove 211. The groove 211 may be in any shape of circle, square, rectangle, triangle, etc., which is not specifically limited herein. It can be understood that, it is possible that at least one groove 211 is provided on the first metal plate 10 and no groove 211 is provided on the second metal plate 20; or it is possible that at least one groove 211 is provided on the second metal plate 20 and no groove 211 is provided on the first metal plate 10; or it is also possible that at least one groove 211 is provided on the first metal plate 10 and at least one groove 211 is provided on the second metal plate 20. The position of the groove 211 is not specifically limited, as long as it does not affect the signal transmitting and receiving of the antenna device. The groove 211 is provided to increase the impedance of the antenna device, and it is conducive to miniaturization of the antenna device and thus allows the low-profile antenna to be conformal to the carrier in the limited space.

In a preferred embodiment of the present invention, a plurality of the antenna devices is provided, the low-profile antenna includes a plurality of array elements arranged in an array, and the array element includes a plurality of antenna devices arranged in an array. For example, the antenna devices are arranged in arrays of 1×2, 1×3, and 1×4 to form the array elements, and then the array elements are formed into large-scale low-profile antenna arrays such as 8T8R (8-channel transceiver antenna), 16T16R (16-channel transceiver antenna), 32T32R (32-channel transceiver antenna), and 64T64R (64-channel transceiver antenna). The arrays allows convenient production and assembly as well as convenient disassembly and maintenance, thereby improving a production efficiency and reducing maintenance cost. It can be understood that the array elements can be formed by the antenna devices arranged in other arrays, and the large-scale low-profile antennas can be formed by the array elements arranged in other arrays.

It should be understood that, the above are merely embodiments of the present invention, those skilled in the art can make improvements without departing from the concept of the present invention, and these improvements shall fall within the protection scope of the present invention.

What is claimed is:

1. An antenna device, comprising:
a first metal plate;
a second metal plate spaced apart from and parallel to the first metal plate in a normal direction of the first metal plate;
a plurality of parasitic posts, wherein each of the plurality of parasitic posts has one end electrically connected to the first metal plate and facing away from the second metal plate, and the other end in no electrical connection;
four feeding posts, wherein each of the four feeding posts has one end electrically connected to the first metal plate and facing away from the second metal plate; and
a feeding plate provided with two differential feeding ports, wherein each of the two differential feeding ports is electrically connected to two of the four feeding posts through a differential feeding wire,
wherein a straight line connecting connection points, at which the two feeding posts corresponding to one of the two differential feeding ports are connected to the first metal plate, is orthogonal to a straight line connecting connection points, at which the two feeding posts corresponding to the other one of the two differential feeding ports are connected to the first metal plate, to allow the antenna device to generate orthogonal polarization.

2. The antenna device as described in claim 1, wherein the plurality of parasitic posts comprises four parasitic posts, and every two of the four parasitic posts are symmetrically arranged at two ends of the two feeding posts corresponding to a same one of the two differential feeding ports, connection points, at which the four feeding posts are connected to the first metal plate, are connected to form a first square, connection points, at which the four parasitic posts are connected to the first metal plate, are connected to form a second square, and two parallel side edges of the first square are parallel to two parallel side edges of the second square.

3. The antenna device as described in claim 1, further comprising an insulation bracket fixed to the feeding plate, wherein the insulation bracket comprises a supporting base spaced apart from and parallel to the feeding plate, a first supporting post extending from the supporting base to the feeding plate and connected to the feeding plate, and a second supporting post extending from the supporting base to the feeding plate and spaced apart from the feeding plate, the first metal plate is provided on a surface of the supporting base facing towards the feeding plate, the four feeding posts are provided on a surface of the first supporting post, and the plurality of parasitic posts is disposed on a surface of the second supporting post.

4. The antenna device as described in claim 3, wherein the second metal plate is riveted to the supporting base through plastic rivets.

5. The antenna device as described in claim 1, wherein at least one of the first metal plate and the second metal plate is provided with a groove.

6. The antenna device as described in claim 5, wherein the groove is in a shape of circle or square.

7. The antenna device as described in claim 5, wherein a distance between a surface of the feeding plate facing away from the four feeding posts and a surface of the second metal plate facing away from the four feeding posts is a height of the antenna device, and the height of the antenna device is 7.5 mm, a working frequency of the antenna device ranges from 3.4 GHz to 3.6 GHz.

8. A low-profile antenna, comprising at least one antenna device, each of the at least one antenna device being the antenna device as described in claim 1.

9. The low-profile antenna as described in claim 8, wherein the at least one antenna device comprises a plurality of antenna devices, the plurality of antenna devices is arranged in arrays to form a plurality of array elements, and the plurality of array elements is arranged in arrays to form the low-profile antenna.

10. The low-profile antenna as described in claim 8, wherein the plurality of parasitic posts comprises four parasitic posts, and every two of the four parasitic posts are symmetrically arranged at two ends of the two feeding posts corresponding to a same one of the two differential feeding ports, connection points, at which the four feeding posts are connected to the first metal plate, are connected to form a first square, connection points, at which the four parasitic posts are connected to the first metal plate, are connected to form a second square, and two parallel side edges of the first square are parallel to two parallel side edges of the second square.

11. The low-profile antenna as described in claim 8, further comprising an insulation bracket fixed to the feeding plate, wherein the insulation bracket comprises a supporting base spaced apart from and parallel to the feeding plate, a first supporting post extending from the supporting base to the feeding plate and connected to the feeding plate, and a second supporting post extending from the supporting base to the feeding plate and spaced apart from the feeding plate, the first metal plate is provided on a surface of the supporting base facing towards the feeding plate, the four feeding posts are provided on a surface of the first supporting post, and the plurality of parasitic posts is disposed on a surface of the second supporting post.

12. The low-profile antenna as described in claim 11, wherein the second metal plate is riveted to the supporting base through plastic rivets.
